(19) United States
(12) Patent Application Publication
(10) Pub. No.: US 2025/0168320 A1
(43) Pub. Date: May 22, 2025

(54) EXTENDED-REALITY RENDERING USING HARDWARE PIXELS-PER-DEGREE ESTIMATIONS, AND SYSTEMS AND METHODS OF USE THEREOF

(71) Applicant: Meta Platforms Technologies, LLC, Menlo Park, CA (US)

(72) Inventors: Rohit Rao Padebettu, San Mateo, CA (US); Nghiep Chinh Luu, Houston, TX (US); Irad Ratmansky, Lebanon, TN (US); Steven Paul Lansel, Apopka, FL (US)

(21) Appl. No.: 18/938,148

(22) Filed: Nov. 5, 2024

Related U.S. Application Data
(60) Provisional application No. 63/600,572, filed on Nov. 17, 2023.

(51) Int. Cl. H04N 13/366; H04N 13/139; H04N 13/156; H04N 13/398

(52) U.S. Cl. CPC H04N 13/366; H04N 13/139; H04N 13/156; H04N 13/398

(57) ABSTRACT

An XR device includes a display device, a lens, and programs. The programs are stored in memory and configured to be executed by processors. Moreover, the programs include instructions for determining an HPPD metric for the XR device based on characteristics of the display device and the lens. The programs also include instructions for receiving data regarding a size and a location of visual XR content from an XR application running on the XR device. Additionally, the programs include instructions for determining an RPPD metric for the visual XR content based on the data. Further, the programs include instructions for determining a recommended resolution for rendering the visual XR content based on the HPPD metric and the RPPD metric. Moreover, the programs include instructions for transmitting the recommended resolution to the XR application, where the XR application is configured to render the visual XR content using the recommended resolution.

### CROSS-REFERENCE TO RELATED APPLICATIONS

This application claims priority to U.S. Prov. Patent App. No. 63/600,572, filed Nov. 17, 2023, entitled “Improving Extended-Reality Rendering Using Hardware Pixels-Per-Degree Estimations, and Systems and Methods of Use Thereof,” which is hereby fully incorporated by reference in its entirety.

### TECHNICAL FIELD

The present disclosure relates, generally, to extended-reality (XR) devices and, more specifically, to scaling and rendering visual XR content for use by said XR devices.

### BACKGROUND

Extended reality (XR) technologies are reshaping how we engage with digital content. By integrating the virtual and physical worlds, these technologies offer immersive experiences that transcend the boundaries of traditional computing interfaces. These experiences foster creativity, accelerate learning, and enhance entertainment.

Key to the potential of XR technologies is user immersion. When a user feels immersed in an XR environment, the digital elements of that environment become an integral part of the user's reality. This allows the user to forget the XR interface and instead focus their attention on the XR environment, thus amplifying the impact of that environment.

Achieving immersion, however, is a complex task. It hinges largely on the precise rendering of XR objects, a challenge compounded by user positioning, environmental factors, hardware constraints, and various other factors. As such, there is a need for innovative solutions that address the intricacies inherent in properly rendering immersive XR environments.

### SUMMARY

The systems and methods described herein provide novel means for scaling and rendering visual XR environments. Many of these systems and methods involve the calculation of a hardware-centric pixels-per-degree (HPPD) metric for a given XR device. As used herein, HPPD refers to the inherent separation of pixels of the display of an XR device as observed by the user of an XR device. When the user's eyes are placed at a nominal position of the XR device and the user looks through the XR device's viewing optics (e.g., lenses), the pitch between adjacent display pixels measured in viewing angle can be scaled appropriately to yield the HPPD metric of the XR device. This value may change across the field of view of the XR device. The HPPD metric can be used, for example, to determine an optimal scaling factor for use in rendering visual XR content. This is discussed in more detail below. Example embodiments of the advancements discussed herein include the following:

An XR device includes a display device, a lens, and one or more programs. The one or more programs are stored in memory and configured to be executed by one or more processors. The one or more programs include instructions for determining an HPPD metric for the XR device based on a characteristic of the display device and a characteristic of the lens. The one or more programs also include instructions for receiving data regarding visual XR content from an XR application running on the XR device. The data includes a size of the visual XR content and a location of the visual XR content. Additionally, the one or more programs include instructions for determining an RPPD metric for the visual XR content based on the data. Further, the one or more programs include instructions for determining a scaling factor for rendering the visual XR content based on the HPPD metric and the RPPD metric. Moreover, the one or more programs include instructions for determining a recommended resolution for the XR application based on the scaling factor. Furthermore, the one or more programs include instructions for transmitting the recommended resolution to the XR application, where the XR application is configured to render the visual XR content using the recommended resolution.

A method of improving rendering of an XR device includes determining an HPPD metric for the XR device based on a characteristic of a display device of the XR device and a characteristic of a lens of the XR device. The method also includes receiving data regarding visual XR content from an XR application running on the XR device. The data includes a size of the visual XR content and a location of the visual XR content. Additionally, the method includes determining an RPPD metric for the visual XR content based on the data. Further, the method includes determining a scaling factor for rendering the visual XR content based on the HPPD metric and the RPPD metric. Moreover, the method includes determining a recommended resolution for the XR application based on the scaling factor. Furthermore, the method includes transmitting the recommended resolution to the XR application, where the XR application is configured to render the visual XR content using the recommended resolution.

A non-transitory, computer-readable storage medium stores instructions that, when executed by one or more processors of an XR device that includes a display device and a lens, cause the XR device to perform operations. The operations include determining an HPPD metric for the XR device based on a characteristic of the display device and a characteristic of the lens. The operations also include receiving data regarding visual XR content from an XR application running on the XR device. The data includes a size of the visual XR content and a location of the visual XR content. Additionally, the operations include determining an RPPD metric for the visual XR content based on the data. Further, the operations include determining a scaling factor for rendering the visual XR content based on the HPPD metric and the RPPD metric. Moreover, the operations include determining a recommended resolution for the XR application based on the scaling factor. Furthermore, the operations include transmitting the recommended resolution to the XR application, where the XR application is configured to render the visual XR content using the recommended resolution.

The features and advantages described in the specification are not necessarily all-inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates example visual XR content that includes a separate user interface (UI) panel for preventing double aliasing, in accordance with some embodiments.

FIGS. 2A-2C illustrate, respectively, magnification, minification, and ideal rendering, in accordance with some embodiments.

FIGS. 3A-3D illustrate example rendering scenarios that may impact RPPD, in accordance with some embodiments.

FIG. 4A illustrates a flow diagram of a method of improving rendering of an XR device, in accordance with some embodiments. Additionally, FIGS. 4B-4C illustrate the method as applied to example XR systems, in accordance with some embodiments.

FIGS. 5A, 5B-1, 5B-2, and 5C illustrate example head-wearable devices, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of XR systems. XR, as described herein, is any superimposed functionality and or sensory-detectable presentation provided by an XR system within a user's physical surroundings. Such XRs can include and/or represent virtual reality (VR), augmented reality (AR), mixed reality (MR), or some combination and/or variation of these realities. For example, a user can perform a swiping in-air hand gesture to cause a song to be skipped by a song-providing API providing playback at, for example, a home speaker. An XR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

XR content can include completely generated content or generated content combined with captured (e.g., real-world) content. The XR content can include video, audio, haptic events, or some combination thereof, any of which can be presented in a single channel or in multiple channels (such as stereo video that produces a three-dimensional (3D) effect to a viewer). Additionally, in some embodiments, XR can also be associated with applications, products, accessories, services, or some combination thereof, which are used, for example, to create content in an XR and/or are otherwise used in (e.g., to perform activities in) an XR.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU)s of a wrist-wearable device) and/or detected via image data captured by an imaging device of a wearable device (e.g., a camera of a head-wearable device)) or a combination of the user's hands. In-air means, in some embodiments, that the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

The proper rendering of visual XR content plays a key role in improving user immersion in an XR environment. This is especially true, for example, for visual XR content that includes fine details such as text. As in the real world, users expect the content to scale and skew in accordance with their position and perspective with respect to it (e.g., increasing in size and clarity as users approach said content). The following figures shed light on the difficulty of properly presenting visual XR content and provide various potential solutions to the problems posed by these difficulties.

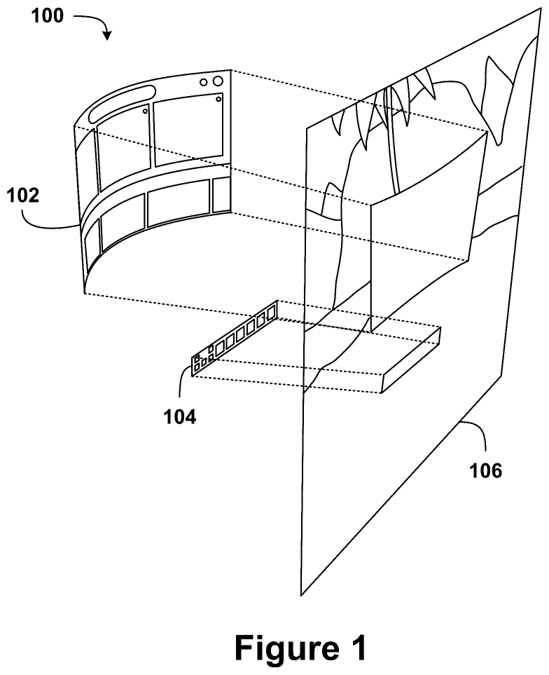

FIG. 1 illustrates example visual XR content 100 that includes a separate UI panel 102 for preventing double aliasing, in accordance with some embodiments. The visual XR content also includes a toolbar 104 and a background image 106. In the illustrated embodiment, the UI panel 102 includes text and other fine details that ought to be presented clearly to a user of the XR device (e.g., XR device 424, AR device 500, and/or VR device 510, below).

Generally, XR textures are rendered into one or more eye buffers (e.g., a left-eye buffer and a right-eye buffer). The XR textures, for example, may be images that correspond to the left and right eyes of the user. Accordingly, the XR textures may need to be geometrically transformed prior to being rendered into an eye buffer. The one or more eye buffers may have a standard perspective transform that roughly corresponds to the field of view of the XR device. After being rendered into the one or more eye buffers, the XR textures are sampled twice-once by an XR application (e.g., XR application 422, below) and again at timewarp. This repeated sampling can lead to sampling artifacts (e.g., poor resolution, flickering, and/or tearing) that may be exacerbated due to the user's changing perspective (e.g., due to head movement). Application developers can prevent this double aliasing problem by submitting an XR texture as a separate layer called a panel, such as the UI panel 102 of FIG. 1.

The XR images presented to each eye of the user of the XR device are generated by sampling from the UI panel 102 and any additional layers (e.g., toolbar 104). These images are presented to the user while still compensating for head movement, lens distortion, and/or other corrections necessary for the XR device's display and/or optics for the panel to appear correctly in the XR environment. The quality of the UI panel 102 may be impacted, for example, when the UI panel 102 undergoes magnification or minification from the texture output by the XR application to the corresponding region of each eye's display.

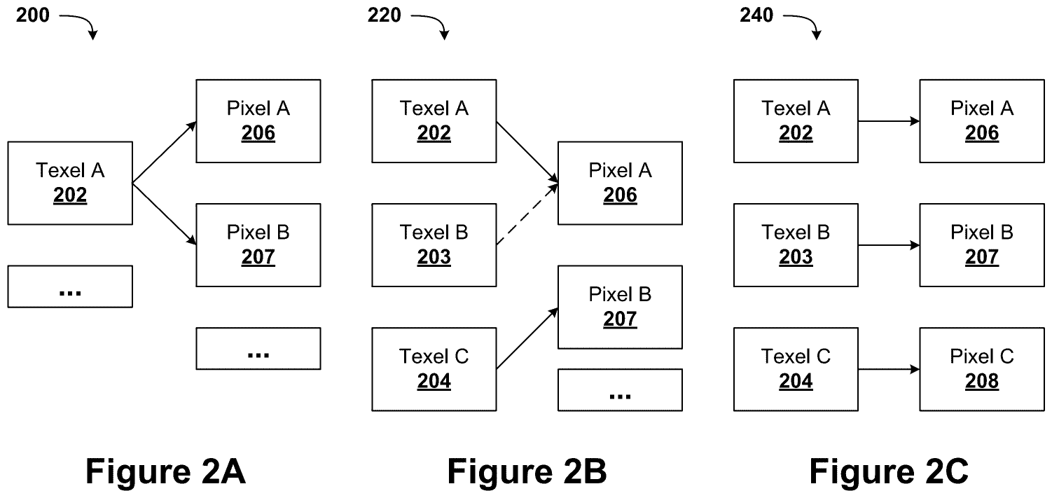

FIGS. 2A-2C illustrate, respectively, magnification 200, minification 220, and ideal rendering 240, in accordance with some embodiments. As illustrated in FIG. 2A, during magnification 200, the aforenoted XR device interpolates and maps a single texel 202 to multiple pixels 206 and 207. This interpolation may cause a panel (e.g., UI panel 102) to appear blurry, which can be especially problematic for text clarity. On the other hand, during minification 220, multiple texels 202 and 203 are mapped to a single pixel 206. This undersampling may cause the panel to flicker due to aliasing, or it may require additional processing—which costs the XR device precious computational and/or memory resources.

Whether rendering will require magnification or minification is largely dependent on pixel density, which can be expressed in terms of two pixels-per-degree (PPD) metrics—render PPD (RPPD) and the aforenoted HPPD metric. As used herein, RPPD refers to the separation of pixels of an XR texture when the texture is placed in the XR world, as seen by a virtual camera at the user's location. When a virtual camera or eye is placed at the user's location, the pitch between adjacent texture pixels if placed across the virtual object approximately placed in the virtual scene measured in viewing angle can be scaled appropriately to yield the RPPD metric. Since this value may vary across the surface of a virtual object, in some embodiments, the RPPD metric is the average RPPD across the entire surface of the virtual object. Alternatively, in some embodiments, the RPPD metric is the RPPD metric as measured at a central point of the virtual object, a corner(s) or edge(s) of the virtual object, a location on the virtual object at which the user's gaze is directed, or an input location of a controller or gesture. The RPPD for a given panel may depend, for example, on the panel field of view, the panel resolution, and/or a viewing distance between the user and the panel. The pixels of the panel are spread out over a virtual surface that subtends a field of view based on the size of the surface and the position of the surface relative to the user.

As noted above, HPPD refers to the inherent separation of pixels of the display of an XR device as observed by the user of an XR device. The HPPD is fixed by the hardware of the XR device. Although HPPD may vary across the field of view, it is more important near the user's forward gaze where the user is likely most comfortable (e.g., as opposed to at the periphery of the XR device's display). Accordingly, in some embodiments, HPPD can be a fixed value for the XR device (e.g., as determined at the user's forward gaze). However, in some embodiments, HPPD is a metric that varies based on a distance from the user's forward gaze. For a given XR device, HPPD may depend, for example, on fill factor, lens blur, subpixel structure, and/or the resolution of the display and/or the lens of the XR device.

As illustrated in FIG. 2C, when individual texels 202-204 can be mapped approximately to pixels 206-208, rendering requires no magnification or minification. This occurs when the RPPD is equal to the HPPD, and it results in a clearer, flicker-free image for the user of the XR device. Adjusting the RPPD for visual XR content to match the HPPD of the XR device can thus improve the rendering of the visual XR content. If, for example, the RPPD of a panel is less than the HPPD of the XR device, then the panel may be scaled up prior to rendering the panel (e.g., using a scaler greater than one). On the other hand, if the RPPD is greater than the HPPD, then the panel can be scaled down prior to rendering the panel (e.g., using a scaler less than one).

Assuming the HPPD is static (e.g., at a center of user's viewing area), the scaling factor used to render the visual XR content (e.g., UI panel 102) can be adjusted to account for changes in RPPD as the user moves with respect to the visual XR content. However, in some embodiments, the XR application may not have access to the HPPD for the XR device or the XR application may not be able to determine the HPPD. For example, HPPD may depend on various lens and/or display properties that may not be available to the XR application or the developers of the XR application. Additionally, RPPD can depend on user position and various other viewing conditions, which the XR application also may not be able to access. Further, RPPD can depend on system resources and/or the type of the XR device. For example, the XR application may need to render a low-RPPD panel due to available system resources to avoid tearing.

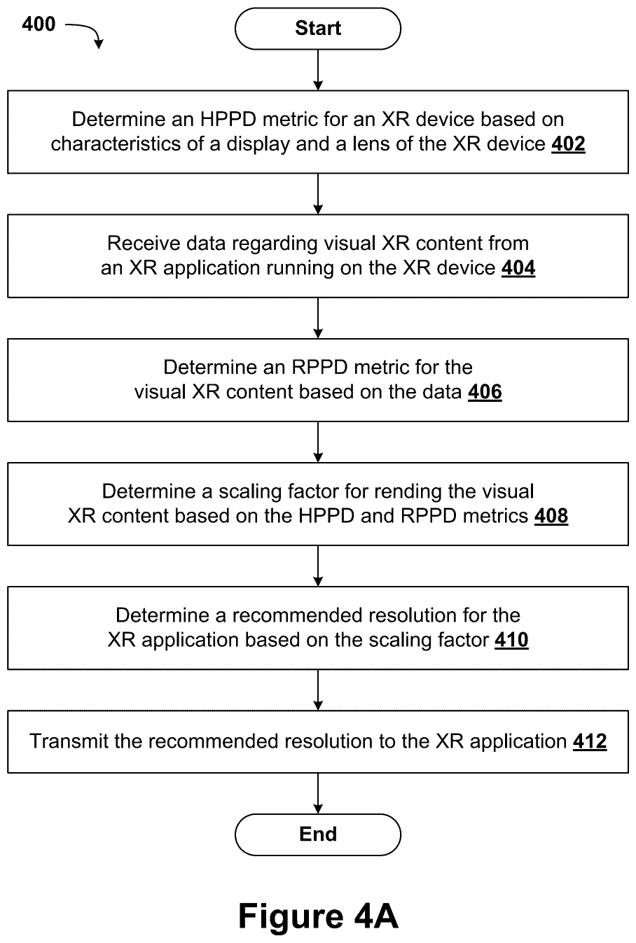

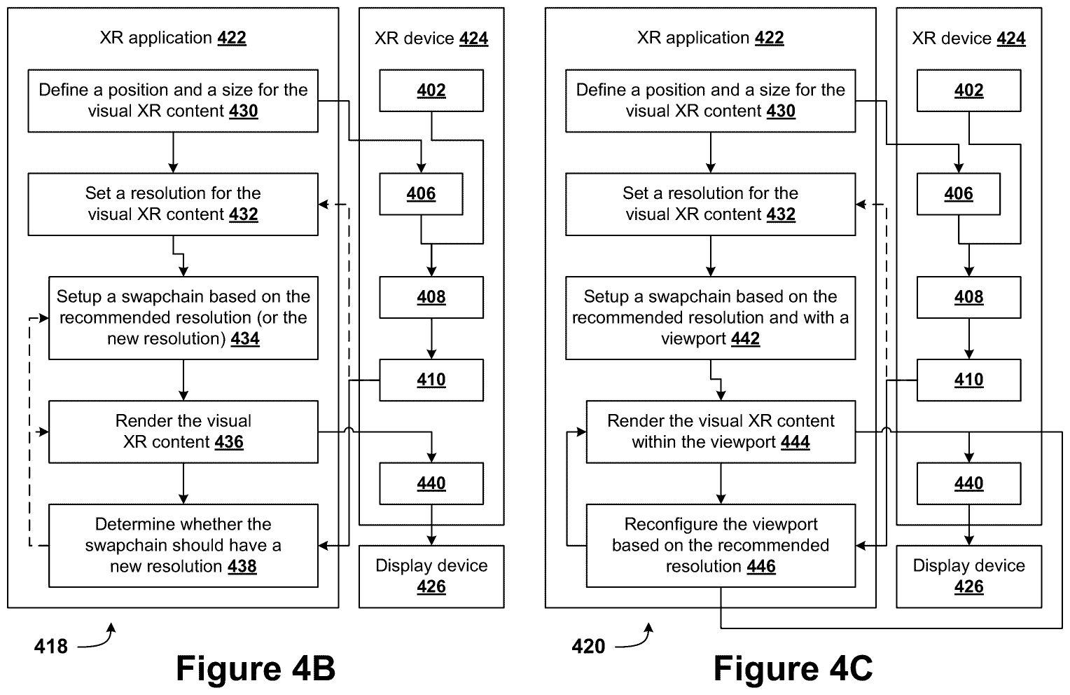

Accordingly, in some embodiments, the XR device (e.g., an operating system thereof) can be configured to determine a scaling factor and/or recommended resolution on behalf of the XR application. This allows the XR application to render the visual XR content while avoiding blurring, flickering, and/or other aliasing artifacts-even if the XR application cannot determine the HPPD of the XR device. This interaction between the XR device and the XR application is discussed in more detail below, with respect to FIGS. 4A-4C.

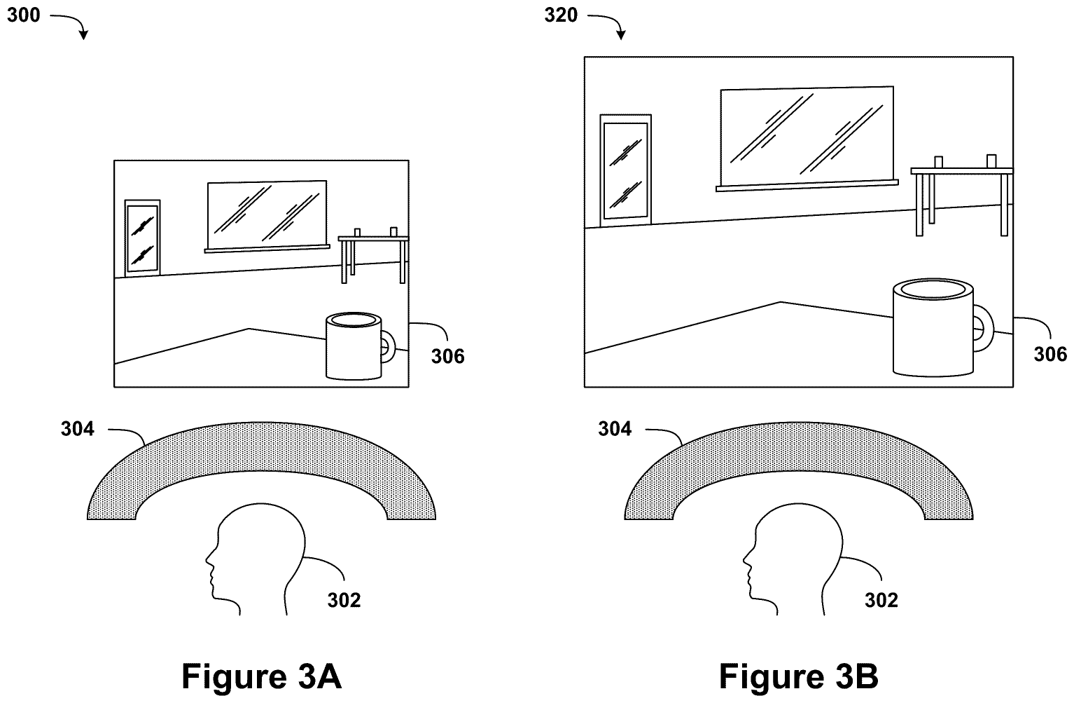

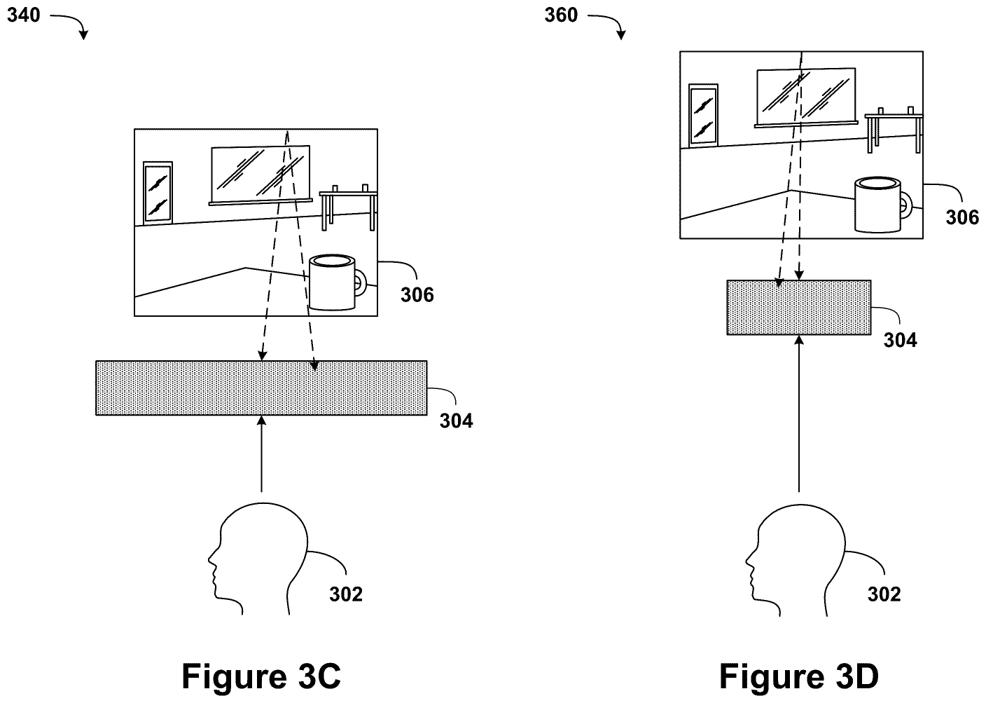

FIGS. 3A-3D illustrate example rendering scenarios 300, 320, 340, and 360 that may impact RPPD, in accordance with some embodiments. During rendering, a panel can be populated by directly sampling from a texture from a buffer such as a swapchain. The quality of the panel can be affected, for example, by the resolution of the texture from which the panel samples and by the field of view of the panel in 3D space. In each of the rendering scenarios 300, 320, 340, and 360, a user 302 of an XR device is presented with an image 306 rendered onto a surface 304 (together forming a rendered panel). The surface 304 may have various properties, such as a width, a height, a curvature, an orientation (e.g., a rotation), or a position (e.g., relative to the user). In some embodiments, the surface occupies the entirety of the user's field of view. The image 306 is a depiction of a texture, or panel contents, at a particular resolution. For example, the image 306 may be rendered at a resolution recommended by the XR device, as discussed in more detail below.

FIGS. 3A-3B illustrate the impact that the resolution of the image 306 can have on the RPPD of the panel—as rendered onto the surface 304. In both FIGS. 3A and 3B, the surface 304 is cylindrical and two-dimensional. In the first rendering scenario 300 of FIG. 3A, the image 306 is a relatively low-resolution texture. This results in a rendered panel with a low RPPD. By contrast, in the second rendering scenario 320 of FIG. 3B, the image 306 is a relatively high-resolution texture, which results in a rendered panel with a higher RPPD. For both of these rendering scenarios, it is assumed that the head of the user 302 is located at a known location relative to the two-dimensional surface of the surface 304.

FIGS. 3C-3D illustrate the impact that distance between the user 302 and the surface 304 can have on the RPPD of the panel-as rendered onto the surface 304. In both FIGS. 3C and 3D, the surface 304 is a two-dimensional quad panel. In the third rendering scenario 340 of FIG. 3C, the distance between the user and the surface 304 is less than the distance between the user and the surface 304 in the fourth rendering scenario 360 of FIG. 3D. Thus, the surface 304 may appear larger in the third scenario 340 than in the fourth scenario 360. This may result in a lower RPPD for the rendered panel in the third scenario 340 than in the fourth scenario 360. Further, it is noted that the difference in apparent size of the surface 304 can be due to the shape of the panel and/or the camera position sampling from a fixed resolution texture.

FIG. 4A illustrates a flow diagram of a method of improving rendering of an XR device (e.g., XR device 424, AR device 500, and/or VR device 510, below), in accordance with some embodiments. Operations (e.g., steps) of the method 400 can be performed by one or more processors (e.g., a central processing unit and/or an MCU) of a system (e.g., a system including the XR device and a wrist-wearable device and/or a handheld intermediary processing device (HIPD), such as a controller). At least some of the operations shown in FIG. 4 correspond to instructions stored in a computer memory (e.g., memory 550A, below) or computer-readable storage medium (e.g., storage, RAM, and/or memory) of the XR device. Operations of the method 400 can be performed by a single device alone or in conjunction with one or more processors (e.g., processor(s) 548A, below) and/or hardware components of another communicatively coupled device and/or instructions stored in memory or computer-readable medium of the other device communicatively coupled to the XR device. In some embodiments, the various operations of the methods described herein are interchangeable and/or optional, and respective operations of the methods are performed by any of the aforementioned devices, systems, or combination of devices and/or systems. For convenience, the method operations will be described below as being performed by a particular component or device but should not be construed as limiting the performance of the operation to the particular device in all embodiments.

As noted above, in some embodiments, a scaling factor can be used for improving the rendering of visual XR content, where the scaling factor is based on a difference (e.g., a quotient) between the RPPD for visual XR content and the HPPD for an XR device. However, an XR application may not be able to determine (e.g., calculate) the HPPD of the XR device. Accordingly, in some embodiments, the XR device determines the HPPD metric, as well as a scaling factor and resolution recommendation, and then sends the scaling factor and/or the resolution recommendation to the XR application.
(A1) FIG. 4A shows a flow chart of a method 400 of improving rendering of an XR device, in accordance with some embodiments. The method 400 occurs at the aforenoted XR device, which has a display device (e.g., an LED display, an OLED display, a projector display) and a lens. In the illustrated embodiment, the method 400 includes determining (402) an HPPD metric for the XR device based on a characteristic of the display device (e.g., a position of the display device relative to the lens and/or an amount of separation between pixels of the display device) and a characteristic of the lens (e.g., a position of the lens relative to an eye of a user of the XR device and/or geometric properties of the lens that impact how the lens bends light that passes therethrough). The HPPD metric may be based on, for example, an amount of separation between pixels of the display device as observed by a user of the XR device. The method 400 also includes receiving (404) data regarding visual XR content (e.g., visual XR content 100, UI panel 102, image 306) from an XR application (e.g., XR application 422, below) running on the XR device. The data may include, for example, a size of the visual XR content and/or a location of the visual XR content. Additionally, the method 400 includes determining (406) an RPPD metric for the visual XR content based on the data. The RPPD metric may be based on, for example, a number of PPD of a viewing angle of the user of the XR device. Further, the method 400 includes determining (408) a scaling factor (e.g., 0.8 or 1.2) for rendering the visual XR content based on the HPPD metric and the RPPD metric. Moreover, the method 400 includes determining (410) a recommended resolution (e.g., 720p or 1080p) for the XR application based on the scaling factor. Furthermore, the method 400 includes transmitting (412) the recommended resolution to the XR application. The XR application may be configured to render the visual XR content using the recommended resolution.
(A2) In some embodiments of A1, the method 400 further includes receiving rendered visual XR content from the XR application, compositing the rendered visual XR content together with a foreground layer to form a composite view.
(A3) In some embodiments of A1-A2, determining the HPPD metric includes measuring (i) a first angle between a first pixel of the display device and an eye position of a user of the XR device and (ii) a second angle between a second pixel of the display device (e.g., adjacent to the first pixel) and the user eye position, and determining the HPPD based on a difference between the first angle and the second angle. Additionally, or alternatively, determining the HPPD metric may include performing a ray tracing simulation to approximate how light bends as it passes from the display device, through the lens, and to an eye of a user of the XR device. Furthermore, determining the HPPD metric may include one or more calculations to map the visual XR content to the display device (e.g., involving geometric distortion). Determinations regarding the HPPD metric of the XR device can be performed prior to runtime (e.g., during manufacturing). In some embodiments, the HPPD metric for the XR device (or a plurality of HPPD metrics, for example, each corresponding to a location on the display device at which a gaze of a user of the XR device might be directed) is stored in a memory of the XR device and then retrieved therefrom by the processor of the XR device.
(A4) In some embodiments of A1-A3, the XR device is an HMD, and the method 400 further includes estimating a head position of a user of the XR device, and determining the RPPD metric is further based on the user head position.
(A5) In some embodiments of A4, the head position is an old head position, and the method 400 further includes estimating a new head position of the user and determining that a difference between the old head position and the new head position satisfies (e.g., meets or exceeds) a movement threshold (e.g., 5 mm, 1 cm, 2 cm). After determining that the difference satisfies the movement threshold, the method 400 further includes (i) redetermining the RPPD metric based on the new head position and the data regarding the visual XR content, (ii) redetermining the scaling factor based on the HPPD metric and the redetermined RPPD metric, (iii) redetermining the recommended resolution based on the redetermined scaling factor, and (iv) transmitting the redetermined recommended resolution to the XR application, where the XR application is further configured to render the visual XR content using the redetermined recommended resolution.
(A6) In some embodiments of A1-A5, the method 400 further includes receiving additional data regarding additional visual XR content from the XR application. The additional data may include, for example, a size of the additional visual XR content and a location of the additional visual XR content. The method 400 may also include redetermining the RPPD metric based on the additional data (e.g., based on the size and/or location of the additional visual XR content). Additionally, the method 400 may include redetermining the scaling factor for rendering the additional visual XR content based on the HPPD metric and the redetermined RPPD metric. Further, the method 400 may include redetermining the recommended resolution based on the redetermined scaling factor and transmitting the redetermined recommended resolution to the XR application. The XR application may be configured to render the additional visual XR content using the redetermined resolution.
(A7) In some embodiments of A5-A6, the method 400 further includes, prior to transmitting the redetermined recommended resolution to the XR application, determining whether a difference between the recommended resolution and the redetermined resolution satisfies a resolution change threshold. If the difference satisfies the resolution change threshold, the method 400 may include transmitting the redetermined recommended resolution to the XR application. However, if the difference does not satisfy the resolution change threshold, the method 400 may include transmitting the recommended resolution to the XR application and forgoing transmitting the redetermined recommended resolution.
(A8) In some embodiments of A1-A7, the method 400 further includes determining an available amount of the memory, a latency of one or more processors of the XR device, and/or a utilization metric of the one or more processors (e.g., indicating a percentage of time the processor is actively executing tasks or processing data relative to its total capacity). Accordingly, determining, the recommended resolution may be further based on the available amount of the memory, the latency, or the utilization metric.
(A9) In some embodiments of A1-A8, the method 400 further includes defining the size of the visual XR content and the location of the visual XR content. The method 400 may also include transmitting the data regarding the visual XR content to the XR device, where the data includes the size and the location of the visual XR content. Additionally, the method 400 may include receiving the recommended resolution from the XR device and setting an initial resolution for the visual XR content based on the recommended resolution. Further, the method 400 may include setting up a swapchain based on the initial resolution, rendering the visual XR content using the swapchain in addition to the recommended resolution, and transmitting the rendered visual XR content to the XR device.
(A10) In some embodiments of A9, the XR application is further configured to receive a redetermined recommended resolution from the XR device and adjust a resolution of the swapchain based on the redetermined recommended resolution.
(A11) In some embodiments of A9-A10, the XR application is further configured to set up a viewport based on the initial resolution, receive a redetermined recommended resolution from the XR device, and adjust a size of the viewport based on the redetermined recommended resolution. The viewport may comprise, for example, a portion of a swapchain texture that is actually used (e.g., occupied by the visual XR content). In this manner, the resolution of the XR application can be changed without needing to change the resolution of the swapchain-by adjusting the size of the viewport. The resolution of the swapchain, in some embodiments, is based on an expected maximum resolution which the XR application will require.
(A12) In some embodiments of A9-A11, the XR application is further configured to receive a redetermined recommended resolution from the XR device and determine that the redetermined recommended resolution satisfies (e.g., meets or exceeds) a resolution threshold. The XR application may also be configured to, after determining that the redetermined recommended resolution satisfies the resolution threshold, adjust a resolution of the swapchain responsive to determining that the redetermined recommended resolution exceeds the resolution threshold.
(A13) In some embodiments of A1-A12, rendering the visual XR content using the recommended resolution (and/or, in some embodiments, the redetermined recommended resolution) substantially improves (e.g., by 10%, 20%, or 50%) a quality of the rendered visual XR content as compared to rendering the visual XR content using a default resolution determined independently of the HPPD metric. This improvement may reduce spatial artifacts, especially those that change over time. The quality or qualities of the rendered visual XR content that may be improved by rendering the visual XR content using the recommended resolution include, for example, a sharpness of the rendered visual XR content, a framerate of the rendered visual XR content, or an amount of aliasing present in the rendered visual XR content (e.g., manifesting as flickering or shimmering).
(B1) In accordance with some embodiments, an XR device includes a display device, a lens, and one or more programs. The one or more programs are stored in memory and configured to be executed by one or more processors. Moreover, the one or more programs include instructions for performing operations corresponding to any of A1-A13.
(C1) In accordance with some embodiments, a non-transitory computer readable storage medium includes instructions that, when executed by a computing device in communication with an XR headset, cause the computer device to perform operations corresponding to any of A1-A13.
(D1) In accordance with some embodiments, a method of operating an XR headset, including operations that correspond to any of A1-A13.
(E1) In accordance with some embodiments, a method of manufacturing an XR device includes providing a display device, a lens, and one or more programs. The one or more programs are stored in memory and configured to be executed by one or more processors. Moreover, the one or more programs includes instructions for performing operations corresponding to A1-A13.

FIGS. 4B-4C illustrate the method 400 as applied to example XR systems 418 and 420, in accordance with some embodiments. Each of the example XR systems 418 and 420 illustrate interaction between an XR device 424 and an XR application 422 (e.g., running on XR device 424). It is noted that, in some embodiments, there is a distinct separation between the XR application 422 and the XR device 424 (e.g., runtime). For example, the application may have minimal complexity and knowledge in comparison to the XR device 424 as a whole.

In the first illustrated embodiment of FIG. 4B, the XR application 422 is configured to define (430) a position and a size for the visual XR content. The XR application 422 is also configured to set (432) a resolution for the visual XR content. This may be based, for example, on a recommended resolution received from the XR device 424 (see operation 410, above). Alternatively, the resolution for the visual XR content can be a default resolution (e.g., based on a user preference). After setting the resolution, the XR application is configured to set up (434) a swapchain based on the recommended resolution (or the new resolution, see below). Further, the XR application 422 is configured to render (436) the visual XR content and determine whether the swapchain should have a new resolution (438).

This first embodiment may involve continually checking the resolution to determine whether it should be adjusted, for example, based on a head position of the user (see, e.g., user 302 relative to surface 304 of FIGS. 3A-3D). The user head position can be determined by the XR device 424 and sent to the XR application thereafter. This determination may occur once per frame or at a lower frequency (e.g., once per frame, once per five frames, or once per second).

Furthermore, in this embodiment, the XR device 424 may recommend a different resolution based on available system resources (e.g., compute, memory, and/or latency) or based on the user's head rotation (or eye rotation) relative to the panel. Lower resolution may be acceptable, for example, if the visual XR content is to be viewed in the user's periphery or at an oblique angle. Moreover, in some embodiments, the swapchain can be modified in place or, in some embodiments, the swapchain can be replaced by an alternate swapchain based on a redetermined resolution (e.g., as received from the XR device 424). Additionally, if the scale factor is within a particular threshold (e.g., a threshold of one), the current resolution can be used. This may reduce the risk and/or cost of frequently minor resolution changes. In some embodiments, it may be desirable to target a scaling factor other than one due to visual quality targets and/or available resources. Accordingly, the target scale factor may be continuously modified based on current system resources and/or demands from other applications.

This first embodiment may require creating a new swapchain after adjusting the resolution, which may risk disruption and cost of generating a parallel swapchain, as well as switching to the new swapchain. The new swapchain requires additional memory and modifies the computing requirements in the compositor. These changes can cause interruptions to the XR application 424 (e.g., rendering interruptions), which may result in visual problems for the user (e.g., stale frames, tearing).

FIG. 4C illustrates a second embodiment that avoids the challenges of the first embodiment by continuously using the same swapchain across different resolutions. The swapchain resolution can remain the same, but the entire buffer may not be used (e.g., for lower resolutions). By rendering and reading from a subset of the frame (e.g., through an appropriate viewport and/or render area), the effective resolution can be modified without reallocating memory or creating a parallel swapchain.

It is noted that this allows for smaller panel resolutions than the initial resolution-but larger resolutions may not be allowed (e.g., if the swapchain was set up only to accommodate the initial resolution). However, if the initial resolution is set to a maximum resolution value for the XR device 424, then the swapchain can accommodate any resolution for which the XR device 424 is capable of rendering XR content. Alternatively, or additionally, the swapchain can be initialized at a temporary upper bound resolution. After a resolution is received from the XR device 424 that exceeds the temporary upper bound resolution, then the swapchain can be replaced with a new swapchain that can accommodate the new resolution. It is also noted that the compositor may need to be informed of the current viewport to properly select the appropriate region from the framebuffer.

As illustrated in FIG. 4C, the XR application 422 is configured to define (430) a position and a size for the visual XR content. The XR application 422 is also configured to set (432) a resolution for the visual XR content (e.g., based on a recommended resolution from the XR device 424). Additionally, the XR application 422 is configured to set up (442) a swapchain based on the recommended resolution and with a viewport. Further, the XR application 422 is configured to render (444) the visual XR content within the viewport and reconfigure (446) the viewport based on the recommended resolution.

Certain combinations of these two embodiments may be advantageous with an appropriate decision mechanism for determining a regular frequency at which the XR application 422 should (i) continue with the current resolution for the visual XR content, (ii) create a new swapchain at a recommended resolution (e.g., from the XR device 424), and/or (iii) adjust the viewport and/or the render area to the recommended resolution.

The devices described above are further detailed below, including headset devices. Specific operations described above may occur as a result of specific hardware, and such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., an XR device and/or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as 3D modeling); (iv) a field-programmable gate array (FPGA) that can be programmed and reconfigured after manufacturing and/or customized to perform specific tasks, such as signal processing, cryptography, and machine learning; and/or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; (iv) and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data, including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement units (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein, biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiogra (ECG or EKG) sensors configured to measure electrical activity of the heart to diagnose heart problems; (iii) electromyography (EMG) sensors configured to measure the electrical activity of muscles and diagnose neuromuscular disorders; and (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) XR applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example Head-Wearable Devices

FIGS. 5A, 5B-1, 5B-2, and 5C show example head-wearable devices, in accordance with some embodiments. Head-wearable devices can include, but are not limited to, AR devices 500 (e.g., AR or smart eyewear devices, such as smart glasses, smart monocles, smart contacts, etc.), VR devices 510 (e.g., VR headsets or head-mounted displays (HMDs)), or other ocularly coupled devices. The AR devices 500 and the VR devices 510 are instances of the XR device 424 and/or the XR devices discussed herein with respect to FIGS. 1-4C, such that the XR device 424 (and other XR devices discussed above) should be understood to have the features of the AR devices 500 and/or the VR devices 510 and vice versa. The AR devices 500 and the VR devices 510 can perform various functions and/or operations associated with navigating through UIs and selectively opening applications, as well as the functions and/or operations described above with reference to FIGS. 1-4C (e.g., determining HPPD, determining scaling factor, determining recommended resolution, and/or rendering visual XR content).

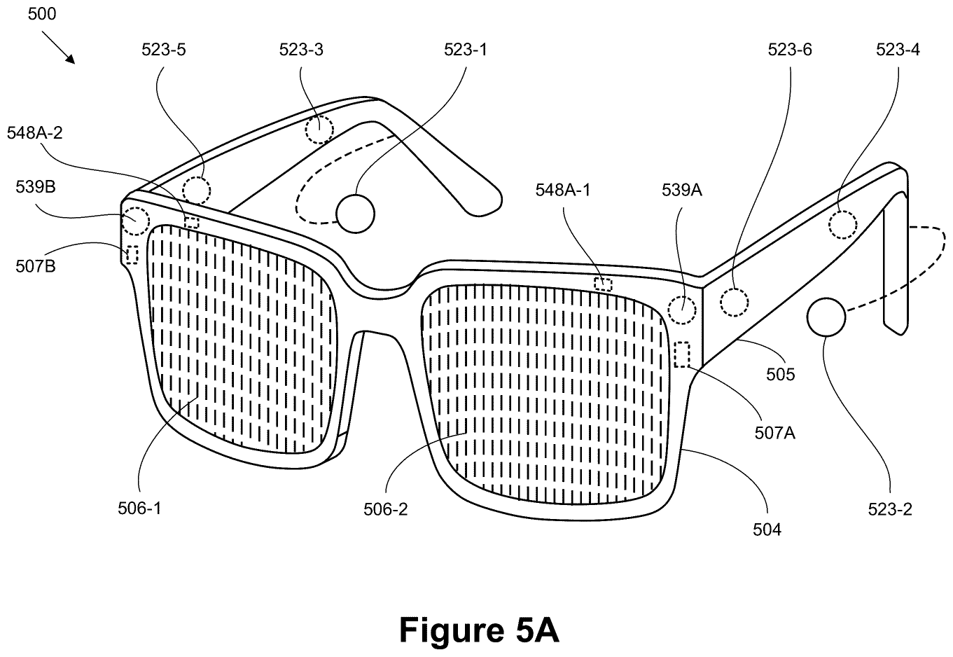

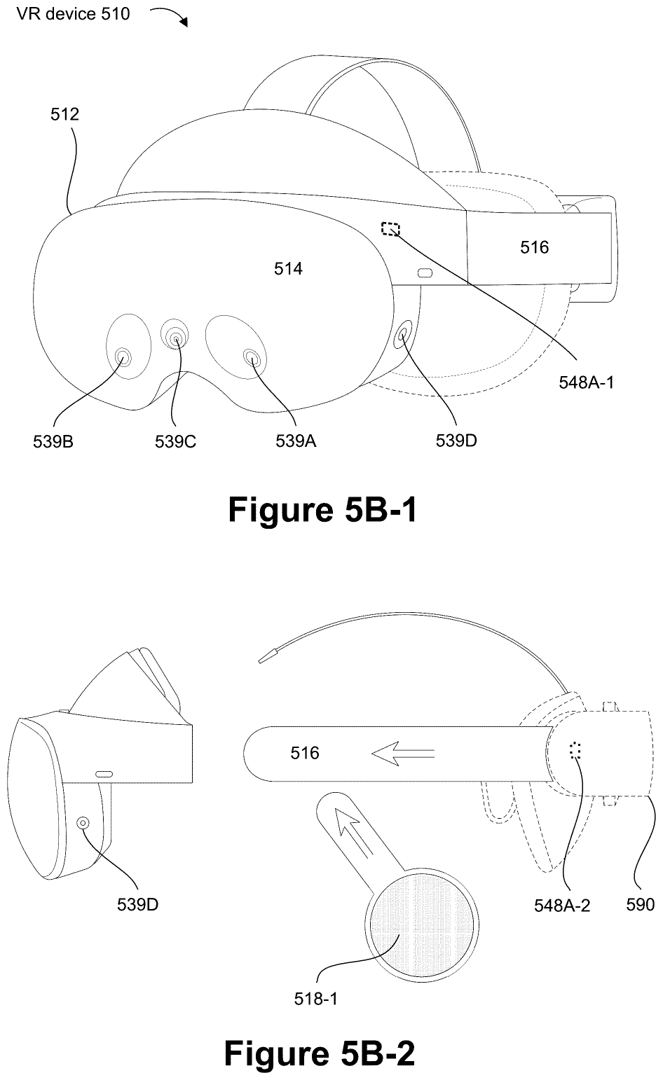

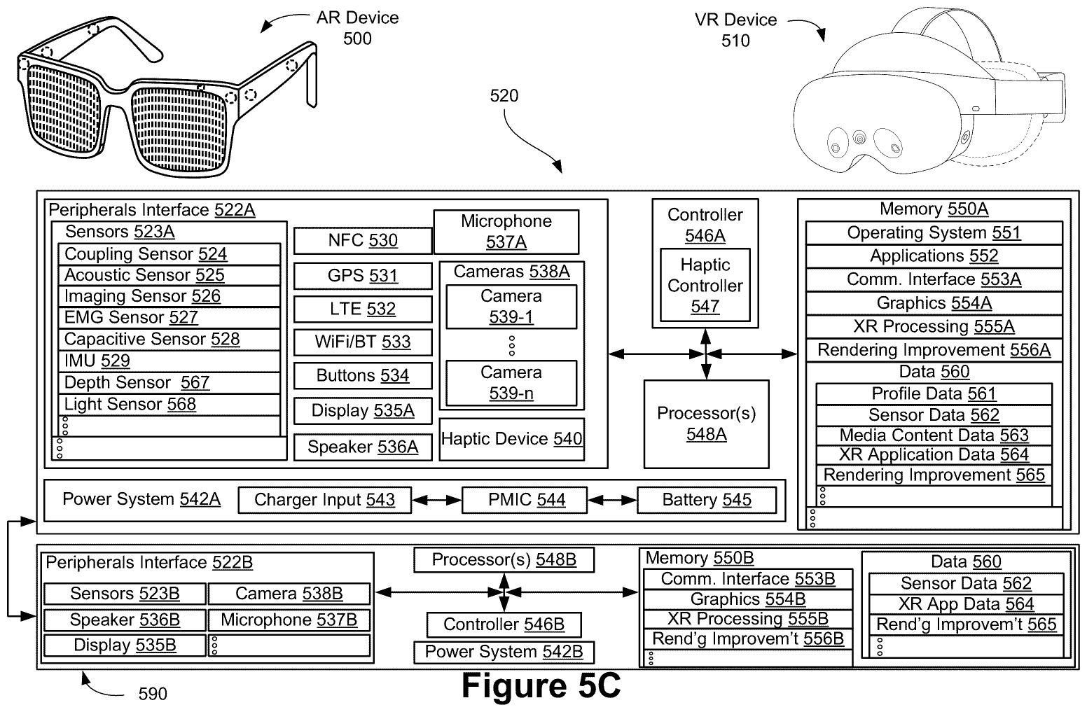

In some embodiments, an XR system includes an AR device 500 (as shown in FIG. 5A) and/or VR device 510 (as shown in FIGS. 5B-1-B-2). In some embodiments, the AR device 500 and the VR device 510 can include one or more analogous components (e.g., components for presenting interactive XR environments, such as processors, memory, and/or presentation devices, including one or more displays and/or one or more waveguides), some of which are described in more detail with respect to FIG. 5C. The head-wearable devices can use display projectors (e.g., display projector assemblies 507A and 507B) and/or waveguides for projecting representations of data to a user. Some embodiments of head-wearable devices do not include displays.

FIG. 5A shows an example visual depiction of the AR device 500 (e.g., which may also be described herein as augmented-reality glasses and/or smart glasses). The AR device 500 can work in conjunction with additional electronic components that are not shown in FIG. 5A, such as a wearable accessory device and/or an intermediary processing device, in electronic communication or otherwise configured to be used in conjunction with the AR device 500. In some embodiments, the wearable accessory device and/or the intermediary processing device may be configured to couple with the AR device 500 via a coupling mechanism in electronic communication with a coupling sensor 524, where the coupling sensor 524 can detect when an electronic device becomes physically or electronically coupled with the AR device 500. In some embodiments, the AR device 500 can be configured to couple to a housing (e.g., a portion of frame 504 or temple arms 505), which may include one or more additional coupling mechanisms configured to couple with additional accessory devices. The components shown in FIG. 5A can be implemented in hardware, software, firmware, or a combination thereof, including one or more signal-processing components and/or application-specific integrated circuits (ASICs).

The AR device 500 includes mechanical glasses components, including a frame 504 configured to hold one or more lenses (e.g., one or both lenses 506-1 and 506-2). One of ordinary skill in the art will appreciate that the AR device 500 can include additional mechanical components, such as hinges configured to allow portions of the frame 504 of the AR device 500 to be folded and unfolded, a bridge configured to span the gap between the lenses 506-1 and 506-2 and rest on the user's nose, nose pads configured to rest on the bridge of the nose and provide support for the AR device 500, earpieces configured to rest on the user's ears and provide additional support for the AR device 500, temple arms 505 configured to extend from the hinges to the earpieces of the AR device 500, and the like. One of ordinary skill in the art will further appreciate that some examples of the AR device 500 can include none of the mechanical components described herein. For example, smart contact lenses configured to present XR to users may not include any components of the AR device 500.

The lenses 506-1 and 506-2 can be individual displays or display devices (e.g., a waveguide for projected representations). The lenses 506-1 and 506-2 may act together or independently to present an image or series of images to a user. In some embodiments, the lenses 506-1 and 506-2 can operate in conjunction with one or more display projector assemblies 507A and 507B to present image data to a user. While the AR device 500 includes two displays, embodiments of this disclosure may be implemented in XR devices (e.g., AR devices) with a single near-eye display (NED) or more than two NEDs.

The AR device 500 includes electronic components, many of which will be described in more detail below with respect to FIG. 5C. Some example electronic components are illustrated in FIG. 5A, including sensors 523-1, 523-2, 523-3, 523-4, 523-5, and 523-6, which can be distributed along a substantial portion of the frame 504 of the AR device 500. The different types of sensors are described below in reference to FIG. 5C. The AR device 500 also includes a left camera 539A and a right camera 539B, which are located on different sides of the frame 504. And the eyewear device includes one or more processors 548A-1 and 548A-2 (e.g., an integral microprocessor, such as an ASIC) that is embedded into a portion of the frame 504.

FIGS. 5B-1 and 5B-2 show an example visual depiction of the VR device 510 (e.g., a head-mounted display (HMD) 512, also referred to herein as an XR headset, a head-wearable device, or a VR headset). The HMD 512 includes a front body 514 and a frame 516 (e.g., a strap or band) shaped to fit around a user's head. In some embodiments, the front body 514 and/or the frame 516 includes one or more electronic elements for facilitating presentation of and/or interactions with an XR and/or VR system (e.g., displays, processors (e.g., processor 548A-1), IMUs, tracking emitters or detectors, or sensors). In some embodiments, the HMD 512 includes output audio transducers (e.g., an audio transducer 518-1), as shown in FIG. 5B-2. In some embodiments, one or more components, such as the output audio transducer(s) 518-1 and the frame 516, can be configured to attach and detach (e.g., are detachably attachable) to the HMD 512 (e.g., a portion or all of the frame 516 and/or the output audio transducer 518-1), as shown in FIG. 5B-2. In some embodiments, coupling a detachable component to the HMD 512 causes the detachable component to come into electronic communication with the HMD 512. The VR device 510 includes electronic components, many of which will be described in more detail below with respect to FIG. 5C.

FIGS. 5B-1 and 5B-2 also show the VR device 510 having one or more cameras, such as the left camera 539A and the right camera 539B, which can be analogous to the left and right cameras on the frame 504 of the AR device 500. In some embodiments, the VR device 510 includes one or more additional cameras (e.g., cameras 539C and 539D), which can be configured to augment image data obtained by the cameras 539A and 539B by providing more information. For example, the camera 539C can be used to supply color information that is not discerned by cameras 539A and 539B. In some embodiments, one or more of the cameras 539A to 539D can include an optional IR (infrared) cut filter configured to remove IR light from being received at the respective camera sensors.

The VR device 510 can include a housing 590 storing one or more components of the VR device 510 and/or additional components of the VR device 510. The housing 590 can be a modular electronic device configured to couple with the VR device 510 (or an AR device 500) and supplement and/or extend the capabilities of the VR device 510 (or an AR device 500). For example, the housing 590 can include additional sensors, cameras, power sources, and processors (e.g., processor 548A-2) to improve and/or increase the functionality of the VR device 510. Examples of the different components included in the housing 590 are described below in reference to FIG. 5C.

Alternatively, or in addition, in some embodiments, the head-wearable device, such as the VR device 510 and/or the AR device 500, includes, or is communicatively coupled to, another external device (e.g., a paired device), such as an HIPD and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckbands may also apply to various other paired devices, such as smartwatches, smartphones, wrist bands, other wearable devices, hand-held controllers, tablet computers, or laptop computers.

In some situations, pairing external devices, such as an intermediary processing device (e.g., an HIPD device, an optional neckband, and/or a wearable accessory device) with the head-wearable devices (e.g., an AR device 500 and/or a VR device 510) enables the head-wearable devices to achieve a similar form factor of a pair of glasses while still providing sufficient battery and computational power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable device overall while allowing the head-wearable device to retain its desired functionality. For example, the intermediary processing device (e.g., an HIPD) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computational capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an XR environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, and/or storage) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, such as an HIPD (e.g., a controller), can process information generated by one or more of its sensors and/or information provided by other communicatively coupled devices. For example, a head-wearable device can include an IMU, and the intermediary processing device (a neckband and/or an HIPD) can compute all inertial and spatial calculations from the IMUs located on the head-wearable device.

AR systems may include a variety of types of visual feedback mechanisms. For example, display devices in the AR devices 500 and/or the VR devices 510 may include one or more liquid-crystal displays (LCDs), light emitting diode (LED) displays, organic LED (OLED) displays, and/or any other suitable type of display screen. XR systems may include a single display screen for both eyes or may provide a display screen for each eye, which may allow for additional flexibility for varifocal adjustments or for correcting a refractive error associated with the user's vision. Some XR systems also include optical subsystems having one or more lenses (e.g., conventional concave or convex lenses, Fresnel lenses, or adjustable liquid lenses) through which a user may view a display screen. In addition to or instead of using display screens, some XR systems include one or more projection systems. For example, display devices in the AR device 500 and/or the VR device 510 may include micro-LED projectors that project light (e.g., using a waveguide) into display devices, such as clear combiner lenses that allow ambient light to pass through. The display devices may refract the projected light toward a user's pupil and may enable a user to simultaneously view both XR content and the real world. XR systems may also be configured with any other suitable type or form of image projection system. As noted, some XR systems may, instead of blending an XR with actual reality, substantially replace one or more of a user's sensory perceptions of the real world with a virtual experience.

While the example head-wearable devices are respectively described herein as the AR device 500 and the VR device 510, either or both of the example head-wearable devices described herein can be configured to present fully immersive VR scenes presented in substantially all of a user's field of view, additionally or alternatively to, subtler augmented-reality scenes that are presented within a portion, less than all, of the user's field of view.

In some embodiments, the AR device 500 and/or the VR device 510 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other XR devices, within other XR devices, and/or in conjunction with other XR devices (e.g., wrist-wearable devices that may be incorporated into headwear, gloves, body suits, handheld controllers, environmental devices (e.g., chairs or floormats), and/or any other type of device or system, such as a wrist-wearable device, an HIPD, and/or a smart textile-based garment), and/or other devices described herein.

FIG. 5C illustrates a computing system 520 and an optional housing 590, each of which shows components that can be included in a head-wearable device (e.g., the AR device 500 and/or the VR device 510). In some embodiments, more or fewer components can be included in the optional housing 590 depending on practical restraints of the respective head-wearable device being described. Additionally, or alternatively, the optional housing 590 can include additional components to expand and/or augment the functionality of a head-wearable device.

In some embodiments, the computing system 520 and/or the optional housing 590 can include one or more peripheral interfaces 522A and 522B, one or more power systems 542A and 542B (including charger input 543, PMIC 544, and battery 545), one or more controllers 546A and 546B (including one or more haptic controllers 547), one or more processors 548A and 548B (as defined above, including any of the examples provided), and memory 550A and 550B, which can all be in electronic communication with each other. For example, the one or more processors 548A and/or 548B can be configured to execute instructions stored in the memory 550A and/or 550B, which can cause a controller of the one or more controllers 546A and/or 546B to cause operations to be performed at one or more peripheral devices of the peripherals interfaces 522A and/or 522B. In some embodiments, each operation described can occur based on electrical power provided by the power system 542A and/or 542B.

In some embodiments, the peripherals interface 522A can include one or more devices configured to be part of the computing system 520. For example, the peripherals interface can include one or more sensors 523A. Some example sensors include one or more coupling sensors 524, one or more acoustic sensors 525, one or more imaging sensors 526, one or more EMG sensors 527, one or more capacitive sensors 528, and/or one or more IMUs 529. In some embodiments, the sensors 523A further include depth sensors 567, light sensors 568, and/or any other types of sensors defined above or described with respect to any other embodiments discussed herein.

In some embodiments, the peripherals interface 522A can include one or more additional peripheral devices, including one or more NFC devices 530, one or more GPS devices 531, one or more LTE devices 532, one or more Wi-Fi and/or Bluetooth devices 533, one or more buttons 534 (e.g., including buttons that are slidable or otherwise adjustable), one or more displays 535A, one or more speakers 536A, one or more microphones 537A, one or more cameras 538A (e.g., including the first camera 539-1 through nth camera 539-n, which are analogous to the left camera 539A and/or the right camera 539B), one or more haptic devices 540, and/or any other types of peripheral devices defined above or described with respect to any other embodiments discussed herein.

The head-wearable devices can include a variety of types of visual feedback mechanisms (e.g., presentation devices). For example, display devices in the AR device 500 and/or the VR device 510 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes) and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 535A can be coupled to each of the lenses 506-1 and 506-2 of the AR device 500. The displays 535A coupled to each of the lenses 506-1 and 506-2 can act together or independently to present an image or series of images to a user. In some embodiments, the AR device 500 and/or the VR device 510 includes a single display 535A (e.g., a near-eye display) or more than two displays 535A.

In some embodiments, a first set of one or more displays 535A can be used to present an augmented-reality environment, and a second set of one or more display devices 535A can be used to present a VR environment. In some embodiments, one or more waveguides are used in conjunction with presenting XR content to the user of the AR device 500 and/or the VR device 510 (e.g., as a means of delivering light from a display projector assembly and/or one or more displays 535A to the user's eyes). In some embodiments, one or more waveguides are fully or partially integrated into the AR device 500 and/or the VR device 510. Additionally, or alternatively, to display screens, some XR systems include one or more projection systems. For example, display devices in the AR device 500 and/or the VR device 510 can include micro-LED projectors that project light (e.g., using a waveguide) into display devices, such as clear combiner lenses that allow ambient light to pass through. The display devices can refract the projected light toward a user's pupil and can enable a user to simultaneously view both XR content and the real world. The head-wearable devices can also be configured with any other suitable type or form of image projection system. In some embodiments, one or more waveguides are provided, additionally or alternatively, to the one or more display(s) 535A.

In some embodiments of the head-wearable devices, ambient light and/or a real-world live view (e.g., a live feed of the surrounding environment that a user would normally see) can be passed through a display element of a respective head-wearable device presenting aspects of the XR system. In some embodiments, ambient light and/or the real-world live view can be passed through a portion, less than all, of an XR environment presented within a user's field of view (e.g., a portion of the XR environment co-located with a physical object in the user's real-world environment that is within a designated boundary (e.g., a guardian boundary) configured to be used by the user while they are interacting with the XR environment). For example, a visual UI element (e.g., a notification UI element) can be presented at the head-wearable devices, and an amount of ambient light and/or the real-world live view (e.g., 15%-50% of the ambient light and/or the real-world live view) can be passed through the UI element, such that the user can distinguish at least a portion of the physical environment over which the UI element is being displayed.

The head-wearable devices can include one or more external displays 535A for presenting information to users. For example, an external display 535A can be used to show a current battery level, network activity (e.g., connected, disconnected), current activity (e.g., playing a game, in a call, in a meeting, or watching a movie), and/or other relevant information. In some embodiments, the external displays 535A can be used to communicate with others. For example, a user of the head-wearable device can cause the external displays 535A to present a “do not disturb” notification. The external displays 535A can also be used by the user to share any information captured by the one or more components of the peripherals interface 522A and/or generated by the head-wearable device (e.g., during operation and/or performance of one or more applications).

The memory 550A can include instructions and/or data executable by one or more processors 548A (and/or processors 548B of the housing 590) and/or a memory controller of the one or more controllers 546A (and/or controller 546B of the housing 590). The memory 550A can include one or more operating systems 551, one or more applications 552, one or more communication interface modules 553A, one or more graphics modules 554A, one or more XR processing modules 555A, a rendering improvement module 556A for improving rending of visual XR content (e.g., based on an HPPD metric), and/or any other types of modules or components defined above or described with respect to any other embodiments discussed herein.

The data 560 stored in memory 550A can be used in conjunction with one or more of the applications and/or programs discussed above. The data 560 can include profile data 561, sensor data 562, media content data 563, XR application data 564, rendering improvement data 565 for storing an HPPD metric of the AR device 500 and/or VR device 510, and/or any other types of data defined above or described with respect to any other embodiments discussed herein.

In some embodiments, the controller 546A of the head-wearable devices processes information generated by the sensors 523A on the head-wearable devices and/or another component of the head-wearable devices and/or communicatively coupled with the head-wearable devices (e.g., components of the housing 590, such as components of peripherals interface 522B). For example, the controller 546A can process information from the acoustic sensors 525 and/or imaging sensors 526. For each detected sound, the controller 546A can perform a direction of arrival (DOA) estimation to estimate a direction from which the detected sound arrived at a head-wearable device. As one or more of the acoustic sensors 525 detect sounds, the controller 546A can populate an audio dataset with the information (e.g., represented by sensor data 562).

In some embodiments, a physical electronic connector can convey information between the head-wearable devices and another electronic device, and/or between one or more processors 548A of the head-wearable devices and the controller 546A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 500 and/or the VR device 510 can include one or more optical sensors such as two-dimensional (2D) or 3D cameras, ToF depth sensors, single-beam or sweeping laser rangefinders, 3D LiDAR sensors, and/or any other suitable type or form of optical sensor. A head-wearable device can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with an XR environment), among a variety of other functions. For example, FIGS. 5B-1 and 5B-2 show the VR device 510 having cameras 539A-539D, which can be used to provide depth information for creating a voxel field and a 2D mesh to provide object information to the user to avoid collisions.

The optional housing 590 can include analogous components to those described above with respect to the computing system 520. For example, the optional housing 590 can include a respective peripherals interface 522B, including more or fewer components to those described above with respect to the peripherals interface 522A. As described above, the components of the optional housing 590 can be used to augment and/or expand on the functionality of the head-wearable devices. For example, the optional housing 590 can include respective sensors 523B, speakers 536B, displays 535B, microphones 537B, cameras 538B, and/or other components to capture and/or present data. Similarly, the optional housing 590 can include one or more processors 548B, controllers 546B, and/or memory 550B (including respective communication interface modules 553B, one or more graphics modules 554B, and one or more XR processing modules 555B) that can be used individually and/or in conjunction with the components of the computing system 520.

The techniques described above in FIGS. 5A-5C can be used with different head-wearable devices. In some embodiments, the head-wearable devices (e.g., the AR device 500 and/or the VR device 510) can be used in conjunction with one or more wearable devices such as a wrist-wearable device (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc., may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. An XR device, comprising:
a display device;
a lens; and
one or more programs, wherein the one or more programs are stored in memory and configured to be executed by one or more processors, the one or more programs including instructions for:
determining a hardware pixels-per-degree (“HPPD”) metric for the XR device based on a characteristic of the display device and a characteristic of the lens;
receiving data regarding visual XR content from an XR application running on the XR device, the data comprising a size of the visual XR content and a location of the visual XR content;
determining a render pixels-per-degree (“RPPD”) metric for the visual XR content based on the data;
determining a scaling factor for rendering the visual XR content based on the HPPD metric and the RPPD metric;
determining a recommended resolution for the XR application based on the scaling factor; and
transmitting the recommended resolution to the XR application, wherein the XR application is configured to render the visual XR content using the recommended resolution.

2. The XR device of claim 1, wherein the one or more programs further include instructions for:
receiving the rendered visual XR content from the XR application;
compositing the rendered visual XR content together with a foreground layer to form a composite view; and
displaying the composite view via the display device.

3. The XR device of claim 1, wherein determining the HPPD metric comprises:
measuring (i) a first angle between a first pixel of the display device and an eye position of a user of the XR device and (ii) a second angle between a second pixel of the display device and the user eye position; and
determining the HPPD based on a difference between the first angle and the second angle.

4. The XR device of claim 1, wherein:
the XR device comprises an HMD;
the one or more programs further include instructions for estimating a head position of a user of the XR device; and
determining the RPPD metric is further based on the user head position.

5. The XR device of claim 4, wherein the head position comprises an old head position, and the one or more programs further include instructions for:
estimating a new head position of the user;
determining that a difference between the old head position and the new head position satisfies a movement threshold; and
responsive to determining that the difference satisfies the movement threshold:
redetermining the RPPD metric based on the new head position and the data regarding the visual XR content;
redetermining the scaling factor based on the HPPD metric and the redetermined RPPD metric;
redetermining the recommended resolution based on the redetermined scaling factor; and
transmitting the redetermined recommended resolution to the XR application, wherein the XR application is further configured to render the visual XR content using the redetermined recommended resolution.

6. The XR device of claim 1, wherein the one or more programs further include instructions for:
receiving additional data that regards additional visual XR content from the XR application, the additional data comprising a size of the additional visual XR content and a location of the additional visual XR content;
redetermining the RPPD metric based on the additional data;
redetermining the scaling factor for rendering the additional visual XR content based on the HPPD metric and the redetermined RPPD metric;
redetermining the recommended resolution based on the redetermined scaling factor; and
transmitting the redetermined recommended resolution to the XR application, wherein the XR application is further configured to render the additional visual XR content using the redetermined recommended resolution.

7. The XR device of either claim 6, wherein the one or more programs further include instructions for, prior to transmitting the redetermined recommended resolution to the XR application:
determining whether a difference between the recommended resolution and the redetermined recommended resolution satisfies a resolution change threshold;
responsive to determining that the difference satisfies the resolution change threshold, transmitting the redetermined recommended resolution to the XR application; and
responsive to determining that the difference does not satisfy the resolution change threshold, transmitting the recommended resolution to the XR application and forgoing transmitting the redetermined recommended resolution.

8. The XR device of claim 1, wherein:
the one or more programs further include instructions for determining an available amount of the memory, a latency of the one or more processors, or a utilization metric of the one or more processors; and
determining the recommended resolution is further based on the available amount of the memory, the latency of the one or more processors, or the utilization metric of the one or more processors.

9. The XR device of claim 1, wherein the XR application is further configured to:
define the size of the visual XR content and the location of the visual XR content;
transmit the data regarding the visual XR content to the XR device after defining the size and the location of the visual XR content;
receive the recommended resolution from the XR device;
set an initial resolution for the visual XR content based on the recommended resolution;
set up a swapchain based on the initial resolution;
render the visual XR content using the swapchain in addition to the recommended resolution; and
transmit the rendered visual XR content to the XR device.

10. The XR device of claim 9, wherein the XR application is further configured to (i) receive a redetermined recommended resolution from the XR device and (ii) adjust a resolution of the swapchain based on the redetermined recommended resolution.

11. The XR device of claim 9, wherein the XR application is further configured to (i) set up a viewport based on the initial resolution, (ii) receive a redetermined recommended resolution from the XR device, and (iii) adjust a size of the viewport based on the redetermined recommended resolution.

12. The XR device of claim 9, wherein the XR application is further configured to (i) receive a redetermined recommended resolution from the XR device, (ii) determine that the redetermined recommended resolution satisfies a resolution threshold, and (iii) adjust a resolution of the swapchain responsive to determining that the redetermined recommended resolution exceeds the resolution threshold.

13. The XR device of claim 1, wherein rendering the visual XR content using the recommended resolution substantially improves a quality of the rendered visual XR content as compared to rendering the visual XR content using a default resolution determined independently of the HPPD metric, the quality of the rendered visual XR content comprising a sharpness of the rendered visual XR content, a framerate of the rendered visual XR content, or an amount of aliasing present in the rendered visual XR content.

14. A method of improving rendering of an XR device, the method comprising:
determining an HPPD metric for the XR device based on a characteristic of a display device of the XR device and a characteristic of a lens of the XR device;
receiving data regarding visual XR content from an XR application running on the XR device, the data comprising a size of the visual XR content and a location of the visual XR content;
determining an RPPD metric for the visual XR content based on the data;
determining a scaling factor for rendering the visual XR content based on the HPPD metric and the RPPD metric;
determining a recommended resolution for the XR application based on the scaling factor; and
transmitting the recommended resolution to the XR application, wherein the XR application is configured to render the visual XR content using the recommended resolution.

15. The method of claim 14, further comprising:
receiving the rendered visual XR content from the XR application;
compositing the rendered visual XR content together with a foreground layer to form a composite view; and
displaying the composite view via the display device.

16. The method of claim 14, wherein determining the HPPD metric comprises:
measuring (i) a first angle between a first pixel of the display device and an eye position of a user of the XR device and (ii) a second angle between a second pixel of the display device and the user eye position; and
determining the HPPD based on a difference between the first angle and the second angle.

17. The method of claim 14, wherein:
the XR device comprises an HMD;
the one or more programs further include instructions for estimating a head position of a user of the XR device; and
determining the RPPD metric is further based on the user head position.

18. A non-transitory computer-readable storage medium storing instructions that, when executed by one or more processors of an XR device that includes a display device and a lens, cause the XR device to:
determine a hardware pixels-per-degree HPPD metric for the XR device based on a characteristic of the display device and a characteristic of the lens;
receive data regarding visual XR content from an XR application running on the XR device, the data comprising a size of the visual XR content and a location of the visual XR content;
determine a render pixels-per-degree RPPD metric for the visual XR content based on the data;
determine a scaling factor for rendering the visual XR content based on the HPPD metric and the RPPD metric;
determine a recommended resolution for the XR application based on the scaling factor; and
transmit the recommended resolution to the XR application, wherein the XR application is configured to render the visual XR content using the recommended resolution.

19. The non-transitory computer readable storage medium of claim 18, wherein the instructions that, when executed by the XR device, also cause the XR device to:
receive the rendered visual XR content from the XR application;
composite the rendered visual XR content together with a foreground layer to form a composite view; and
display the composite view via the display device.

20. The non-transitory computer readable storage medium of claim 18, wherein determining the HPPD metric comprises:
measuring (i) a first angle between a first pixel of the display device and an eye position of a user of the XR device and (ii) a second angle between a second pixel of the display device and the user eye position; and
determining the HPPD based on a difference between the first angle and the second angle.
